(19) United States
(12) Patent Application Publication
(10) Pub. No.: US 2015/0137486 A1
(43) Pub. Date: May 21, 2015

(54) SPHERICAL PLAIN BEARING FOR AN ARTICULATED JOINT

(71) Applicant: ROLLER BEARING COMPANY OF AMERICA, INC., Oxford, CT (US)

(72) Inventors: Bradley Smith, New Britain, CT (US); James Voisine, Burlington, CT (US)

(73) Assignee: ROLLER BEARING COMPANY OF AMERICA, INC., Oxford, CT (US)

(21) Appl. No.: 14/514,676

(22) Filed: Oct. 15, 2014

Related U.S. Application Data
(60) Provisional application No. 61/890,954, filed on Oct. 15, 2013.

(51) Int. Cl. F16C 33/10; B60D 1/58; B60D 1/06; F16C 33/74; F16C 17/10

(52) U.S. Cl. CPC F16C 33/1065; F16C 33/74; F16C 17/105; B60D 1/06; B60D 1/586
USPC 280/511; 384/291; 384/292; 384/145

(57) ABSTRACT

A spherical plain bearing is configured for use within an articulated joint in an articulating vehicle. The spherical plain bearing includes an outer member defining an exterior surface and an interior surface which defines an interior engagement surface, and an inner member is encircled at least partially by the outer member. The inner member has an interior surface defining a bore therethrough, and an exterior surface defining an exterior engagement surface. A radial gap extends between the interior engagement surface and the exterior engagement surface. A lubricant is disposed in the radial gap and a diamond chromium composite matrix hard coating is disposed on the interior engagement surface and the exterior engagement surface.

### CROSS-REFERENCE TO RELATED APPLICATION

This application claims the benefit of U.S. Provisional Patent Application Ser. No. 61/890,954, filed on Oct. 15, 2013, which is incorporated herein by reference in its entirety.

### TECHNICAL FIELD

The present invention is directed to bearings and, more particularly, to spherical plain bearings configured for use with an articulated joint of an articulating vehicle.

### BACKGROUND

An articulating vehicle is a vehicle, typically a large vehicle that is constructed or assembled from two or more sections that are pivotally joined together by an articulated joint. The configuration provides greater capacity and flexibility of movement of the articulating vehicle thereby facilitating the control, steering and turning of vehicle. Examples of an articulating vehicle include a tractor and a trailer (i.e., a tractor-trailer), heavy construction equipment, buses, trams and trains. Typically, the articulated joint pivotally joins a structural frame member of each of the adjoining sections of the articulating vehicle by employing a roller bearing, for example a spherical plain bearing, received within the structural frame members. The articulated joint may provide a permanent, semi-permanent or temporary pivotal connection between the structural frame members of the adjoining sections of the articulating vehicle.

Bearings, particularly spherical plain bearings, are necessary to reduce friction between moving parts of a mechanical assembly such as the structural frame members of the adjoining sections of the articulating vehicle. Spherical bearing assemblies traditionally comprise an inner member positioned for rotational movement in relation to an outer member. The inner member typically comprises a ball having a spherical outer diameter that defines an outer engagement surface and, typically, a bore passes through the ball. The outer member typically comprises an outer ring having a spherical inner diameter that defines an inner engagement surface contoured to receive and retain the inner member therein. A lubricant gel, paste, or liquid such as grease, or a low-friction liner, is typically provided between the inner member and the outer member to reduce friction therebetween.

Spherical Plain Bearings used in the articulated joint of articulating vehicles are subjected to small angle and high frequency oscillations. These conditions are not conducive for providing and replenishing lubrication to separate the sliding contacting surfaces of a spherical plain bearing and results in damage to such sliding contacting surfaces.

### SUMMARY

In one aspect, the present invention resides in a spherical plain bearing configured for use within an articulated joint in an articulating vehicle, the spherical plain bearing comprising: an outer member defining an exterior surface and an interior surface which defines an interior engagement surface; an inner member encircled at least partially by the outer member, the inner member having an interior surface defining a bore therethrough, and an exterior surface defining an exterior engagement surface; a radial gap extending between the interior engagement surface and the exterior engagement surface; a lubricant disposed in the radial gap; and a hard coating disposed on the interior engagement surface and the exterior engagement surface. The hard coating is a diamond chromium composite matrix coating.

In another aspect, the present invention resides in an articulated joint of an articulating vehicle comprising: a first structural member extending rearwardly from a forward section of the articulating vehicle, the first structural member defining a bore at an aft end thereof; a second structural member extending forwardly from an aft section of the articulating vehicle, the first structural member defining a bore at an aft end thereof; an articulated joint housing received within the first structural member bore and the second structural member bore; and a spherical plain bearing disposed in the articulated joint housing, the spherical plain bearing configured for use within an articulated joint in an articulating vehicle. The spherical plain bearing comprises an outer member defining an exterior surface and an interior surface which defines an interior engagement surface, an inner member encircled at least partially by the outer member, the inner member having an interior surface defining a bore therethrough, and an exterior surface defining an exterior engagement surface, a radial gap extending between the interior engagement surface and the exterior engagement surface, a lubricant disposed in the radial gap, a diamond chromium composite matrix coating disposed on the interior engagement surface and the exterior engagement surface, and a lubrication management arrangement having at least one outer member lubrication hole defined in the outer member, at least one inner member exterior groove defined in the exterior engagement surface and in fluid communication with the outer member lubrication hole.

In another aspect, the present invention resides in a method for providing and replenishing a lubricant in an articulated joint of an articulating vehicle, the method comprising: providing an articulated joint housing received within a bore at an aft end of a first structural member extending rearwardly from a forward section of the articulating vehicle and a bore at a forward end of a second structural member extending forwardly from an aft section of the articulating vehicle; and providing a spherical plain bearing disposed in the articulated joint housing, the spherical plain bearing configured for use within an articulated joint in an articulating vehicle. The spherical plain bearing comprises an outer member defining an exterior surface and an interior surface which defines an interior engagement surface, an inner member encircled at least partially by the outer member, the inner member having an interior surface defining a bore therethrough, and an exterior surface defining an exterior engagement surface, a radial gap extending between the interior engagement surface and the exterior engagement surface, a lubricant disposed in the radial gap, a diamond chromium composite matrix coating disposed on the interior engagement surface and the exterior engagement surface, and a lubrication management arrangement having at least one outer member lubrication hole defined in the outer member, at least one inner member exterior groove defined in the exterior engagement surface and in fluid communication with the outer member lubrication hole. The method further includes injecting the lubricant into the spherical plain bearing lubrication management arrangement through the outer member lubrication hole to the inner member exterior groove and dispersing the lubricant over the interior engagement surface and the exterior engagement surface.

### BRIEF DESCRIPTION OF THE DRAWINGS

FIG. 1 is a perspective view of one embodiment of an articulating vehicle in accordance with the present invention.

FIG. 2 is a side view of the articulating vehicle of FIG. 1.

FIG. 3 is a perspective view of the articulating joint of the articulating vehicle of FIG. 1.

FIG. 4 is an isometric view of the articulating joint of FIG. 3.

FIG. 5 is a top plan view of one embodiment of a spherical plain bearing configured for use with an articulated joint of an articulating vehicle in accordance with the present invention.

FIG. 6 is a cross-sectional view of the spherical plain bearing of FIG. 5 taken along line 6-6.

FIG. 7 is a perspective view of another embodiment of a spherical plain bearing configured for use with an articulated joint of an articulating vehicle in accordance with the present invention.

FIG. 8 is a cross-sectional view of the spherical plain bearing of FIG. 7 taken along line 8-8.

FIG. 9 is a top plan view of the inner member of the spherical plain bearing of FIG. 7.

FIG. 10 is a perspective view of other embodiment of an outer member of the spherical plain bearing of FIG. 7.

FIG. 11 is a perspective view of other embodiment of an outer member of the spherical plain bearing of FIG. 7.

FIG. 12 is a perspective view of another embodiment of a spherical plain bearing configured for use with an articulated joint of an articulating vehicle in accordance with the present invention.

FIG. 13 is a cross-sectional view of the spherical plain bearing of FIG. 12 taken along line 13-13.

FIG. 14 is a top plan view of the inner member of the spherical plain bearing of FIG. 12.

### DESCRIPTION OF THE INVENTION

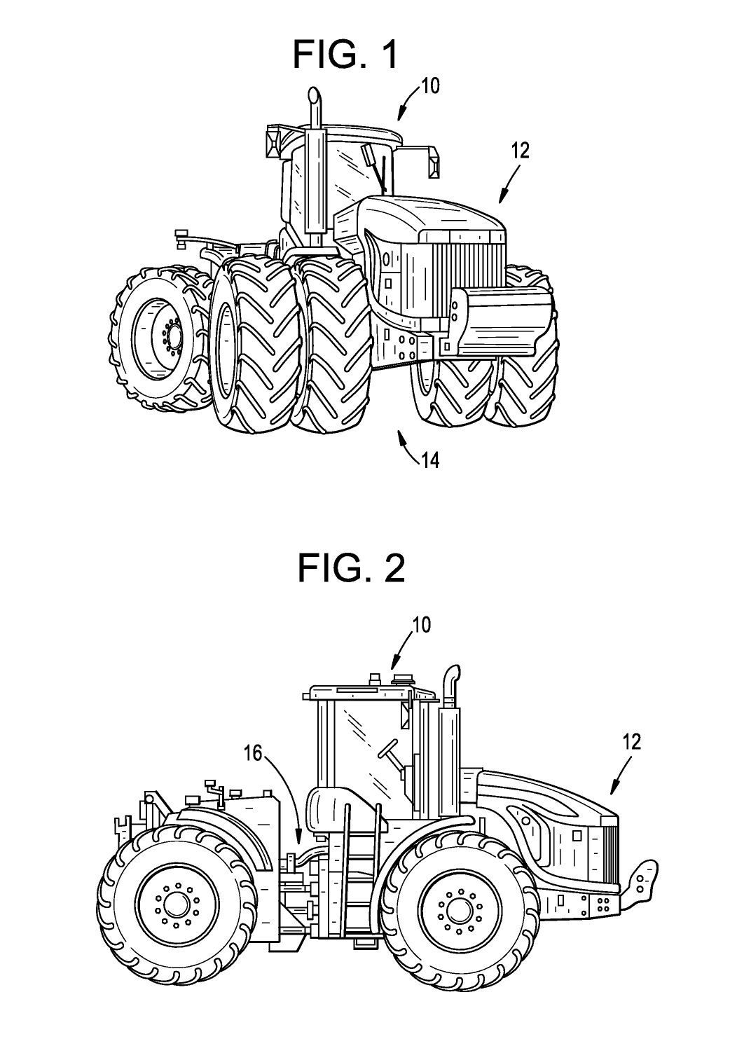

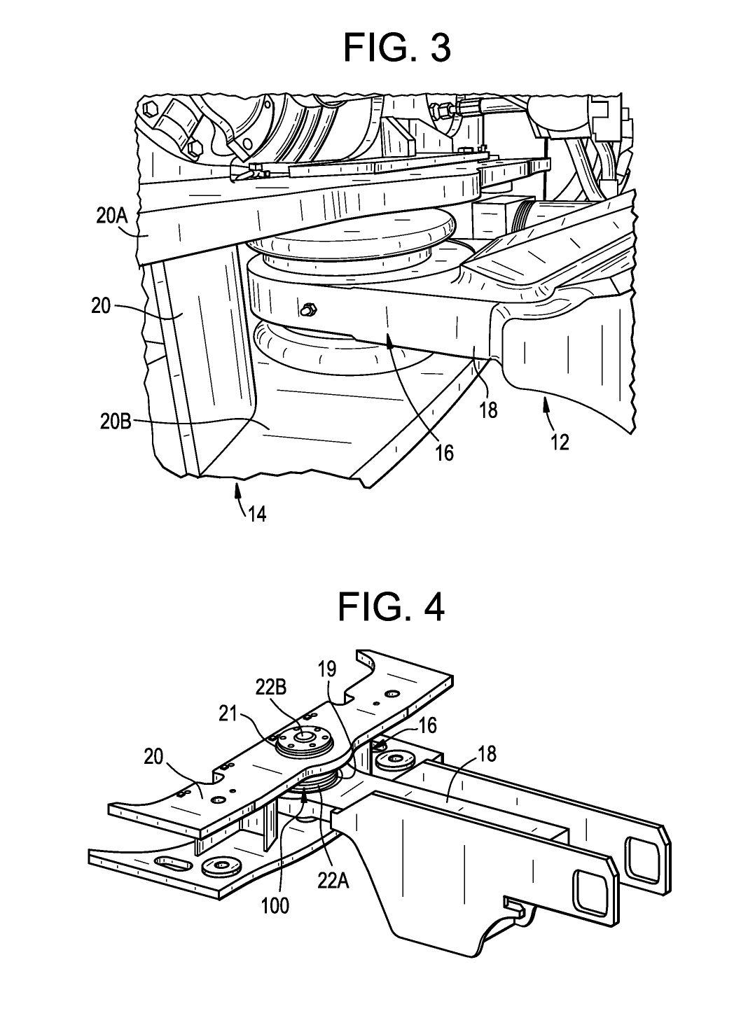

As shown in FIGS. 1 and 2, an articulating vehicle 10, for example a tractor for heavy construction, comprises a first or forward section 12 and a second or aft section 14 that are pivotally joined together by an articulated joint 16. As shown in FIGS. 3 and 4, a first structural member 18 extends rearwardly from forward section 12 and is received within a second structural section 20 extending forwardly from aft section 14. In one embodiment, the second structural section 20 comprises a pair of substantially parallel and spaced apart flanges 20A and 20B Each of the first and second structural members 18 and 20 are fixedly attached to the respective first and second sections 12 and 14 of the articulating vehicle 10 by substantially robust means such as, for example by welding. While the forward section 12 is shown and described as having a first structural member 18 extending therefrom and received within a second structural section 20 extending forwardly from second section 14, the present invention is not limited in this regard as other configurations of overlapping structural members extending from one of forward section 12 and second section 14 and received within the other one of forward section 12 and second section 14 can be employed without departing from the broader aspects of the present invention. While the first and second structural members 18 and 20 are shown and described as being fixedly attached to respective first and second sections 12 and 14, the present invention is not limited in this regard as first and second structural members 18 and 20 may be integrally formed with respective first and second sections 12 and 14.

Articulated joint 16 includes a spherical plain bearing configured for use with articulated joint 16 of articulating vehicle 10 and is designated generally by the reference number 100 and is hereinafter referred to as “bearing 100.” As further shown in FIG. 4, an aft end of first structural member 18 includes a bore 19 therethrough, and a forward end of second structural member 20 includes a bore 21 therethrough. Respective bores 19 and 21 of structural members 18 and 20 are configured for receiving an articulated joint housing 22A therein or therethrough. In one embodiment, bearing 100 is disposed within articulated joint housing 22A and receives a shaft 22B or like component therethrough.

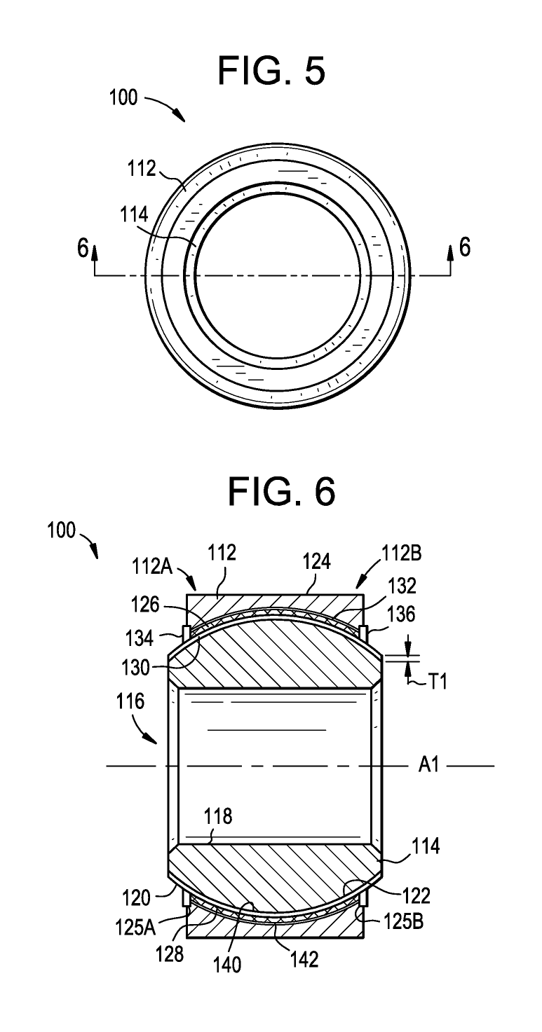

As shown in FIGS. 5-6, bearing 100 comprises an outer member 112, or outer ring, and an inner member 114, or inner ring, encircled at least partially by the outer member 112. The outer member 112 and the inner member 114 are both generally annular and share a common central axis Al. As further shown in FIG. 6, the inner member 114 includes an interior surface 118, such as but not limited to a substantially cylindrical surface that defines a central aperture or a bore 116 for receiving shaft 22B therethrough. The inner member 114 has an arcuate exterior surface 120, such as a convex spherical surface, a portion of which defines an exterior engagement surface 122. The outer member 112 has a substantially cylindrical exterior surface 124 and an arcuate interior surface 126, such as but not limited to a concave spherical surface which defines an interior engagement surface 128 of the outer member 112. A radial gap 130 extends between the interior engagement surface 128 of the outer member 112 and the exterior engagement surface 122 of the inner member 114 when the inner member 114 is encircled at least partially by the outer member 112. A lubricant 132 is disposed in the radial gap 130. Lubricant 132 selectively comprises a thin film of grease, a lubricant gel or paste, or the like to reduce friction between interior engagement surface 128 and exterior engagement surface 122.

As further shown in FIG. 6, outer member 112 further defines a first axial end or first end 112A and a second axial end or second end 112B. In one embodiment, a first seal 134, such as for example a retaining ring, is selectively positioned at or proximate to first axial end 112A and extends radially across gap 130 to inhibit dust and debris from entering gap 130 and to maintain the lubricant 132 in gap 130. A corresponding second seal 134 is selectively positioned at or proximate to second axial end 112B. Seals 134 and 136 are generally annular and share common central axis Al. In one embodiment, seals 134 and 136 are fitted within a respective receiving channel 125A and 125B of outer member 112 by, for example, press-fitting. While seals 134 and 136 are shown and described as fitted within respective receiving channels 125A and 125B of outer member 112, the present invention is not limited in this regard as other configurations of a seal extending across gap 130, such as for example a deformable resilient seal, a seal having a curvilinear portion extending between a first end and a second end, and the like can be employed without departing from the broader aspects of the present invention. Such seals may be fabricated from, for example, a polymeric material, an elastomer, graphite, metal or metal alloy, or a combination of such materials.

Bearing 100, configured for use with articulated joint 16 of articulating vehicle 10, is subjected to small angle and high frequency oscillations. Such conditions are not conducive for providing and replenishing lubricant 132. In one embodiment as shown in FIG. 6, exterior engagement surface 122 of inner member 114 comprises a hard coating 140; and interior engagement surface 128 of outer member 112 comprises a hard coating 142. Hard coatings 140 and 142 having a depth or thickness T1 increase a surface hardness of exterior surface 120 and interior surface 126, and reduce a coefficient of friction between the interior engagement surface 128 of the outer member 112 and the exterior engagement surface 122 of the inner member 114 and thus increase resistance to surface damage under starved lubrication conditions. In one embodiment, hard coatings 140 and 142 exhibit a coating thickness T1 up to about 0.001 inch. In one embodiment, hard coatings 140 and 142 exhibit a coating thickness T1 up to about 0.0005 inch. In one embodiment, hard coatings 140 and 142 exhibit a coating thickness T1 up to about 0.0003 inch. In one embodiment, hard coatings 140 and 142 exhibit a coating thickness T1 in the range of about 0.0001 inch to about 0.0003 inch.

Preferably, exterior engagement surface 122 of inner member 114 and interior engagement surface 128 of outer member 112 exhibit a desired hardness rating such that bearing 100 provides optimal performance when configured for use with articulated joint 16 of articulating vehicle 10. In one embodiment, engagement surfaces 122 and 128 are coated with a composite matrix typically reserved for cutting tools. For example, in one embodiment, hard coatings 140 and 142 comprise a diamond chromium composite matrix coating having ultra-high dispersion of nanometer sized, spherical shaped diamond particles within a chromium substrate. Such a coating provides superior abrasion protection and corrosion resistance with excellent lubricity and release in comparison with conventional hard chrome plating or titanium nitride. Some conventional hard coatings have a tendency to chip or flake due to high contact pressures wherein such chipping causes substantial wear of a bearing because the hard chips work the bearing contact surfaces like a grinding wheel. The diamond chromium composite matrix coating exhibits excellent adhesion properties and does not fracture from the substrate (e.g., the outer member 112 and the inner member 114) unless the substrate itself fractures or fatigues. Hard coatings 140 and 142 selectively exhibit a Rockwell hardness rating greater than 85 Hardness Rockwell C (“HRc”).

In one embodiment of bearing 100 having engagement surfaces 122 and 128 that exhibit a desired Rockwell hardness rating greater than 85 HRc, hard coatings 140 and 142 comprise an Armoloy® XADC Diamond Chromium coating such as, for example, 98Rc XADC-Armoloy® coating (Armoloy® is a registered trademark of Armoloy Corporation). As a result, the novel composition of engagement surfaces 122 and 128 of bearing 100 having respective hard coatings 140 and 142, the engagement surfaces 122 and 128 selectively exhibit a Rockwell hardness of about HRc 98. A slight improvement in wear resistance of bearing 100 in the range of about 25% to about 50% was expected; however, testing has shown an unexpected 500% improvement in wear resistance over traditional steel on steel, greased, spherical plain bearings. For example, a prior art bearing was cycle tested under load until an axial clearance of 0.005 inches was measured at 33 hours into the testing. However, the bearing of the present invention having the diamond chromium composite matrix disposed on the interior engagement surface e.g., 128, 228 and the exterior engagement surface e.g., 122, 222 was subject to the same cyclic load testing and after 250 hours the 0.005 axial clearance was, surprisingly, not reached. While prior art coatings can flake off and accelerate bearing wear by adding abrasive particles into the grease. However, surprisingly, the diamond chromium composite matrix coating had sufficient adhesion so as not to flake off of interior engagement surface e.g., 128, 228 and the exterior engagement surface e.g., 122, 222 and add abrasive particles to the grease.

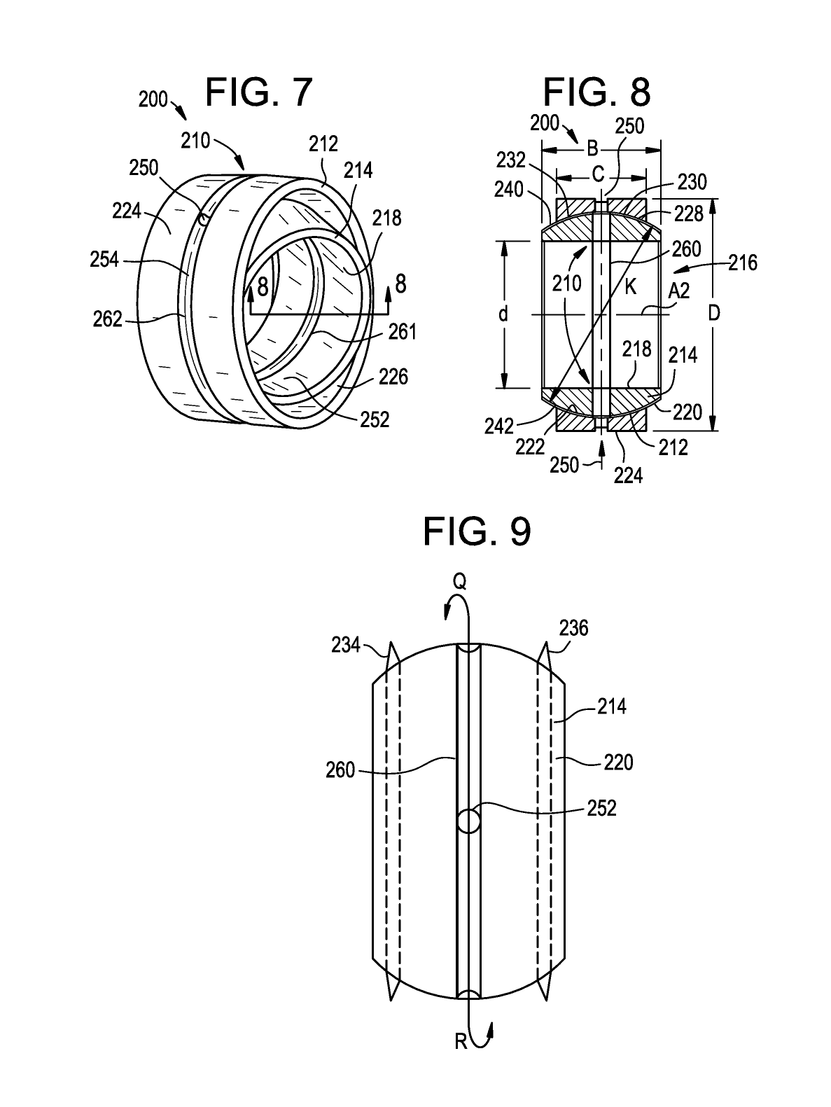

Providing the bearing contact surfaces of a bearing 100 with a diamond chromium composite matrix coating is particularly useful in combination with a bearing comprising a lubrication management arrangement. Bearing 200 is depicted in FIG. 7-9 and is similar to bearing 100 shown in FIGS. 5 and 6, thus like elements are given a like element number preceded by the numeral 2. Bearing 200 includes a lubrication management arrangement 210.

As shown in FIGS. 7-9, bearing 200 comprises an outer member 212, or outer ring, and an inner member 214, or inner ring, encircled at least partially by the outer member 212. The outer member 212 and the inner member 214 are both generally annular and share a common central axis A2. Inner member 214 includes an interior surface 218 that defines a bore 216 for receiving shaft 22B therethrough. The inner member 214 has an arcuate exterior surface 220, such as a convex spherical surface, a portion of which defines an exterior engagement surface 222. The outer member 212 has a substantially cylindrical exterior surface 224 and an arcuate interior surface, such as but not limited to a concave spherical surface which defines an interior engagement surface 228 of the outer member 212. A radial gap 230 extends between the interior engagement surface 228 of the outer member 212 and the exterior engagement surface 222 of the inner member 214 when the inner member 214 is encircled at least partially by the outer member 212. A lubricant 232 is disposed in the radial gap 230. Lubricant 232 selectively comprises a thin film of grease, a lubricant gel or paste, or the like to reduce friction between the interior engagement surface 228 and the exterior engagement surface 222. In one embodiment as shown in FIG. 9, a first seal 234 and a second seal 236 extend radially across gap 230 to inhibit dust and debris from entering gap 230 and to maintain the lubricant 232 in gap 230. Exterior surface 220 of inner member 214 and interior surface 226 of outer member 212 respectively comprise a hard coating 240 and 242, such as for example a diamond chromium composite matrix coating.

As further shown in FIGS. 7 and 8, bearing 200 includes lubrication management arrangement 210 comprising lubrication holes and grooves for providing and replenishing lubricant 232. Use of bearing 200 having lubrication management arrangement 210 further improves the distribution of lubricant and facilitates relubrication purging to flush out wear debris and contaminants. Outer member 212 comprises at least one outer member lubrication hole 250 therethrough, and selectively a plurality of outer member lubrication holes 250 therethrough, to provide for the dispersion of lubricant 232 to interior surface 218 of inner member 214. In one embodiment, exterior surface 224 of outer member 212 defines an annular outer member exterior groove 262 in fluid communication with each of outer member lubrication holes 250 to further provide for the dispersion of lubricant 232 therein, and also to provide dispersion of lubricant 232 between exterior surface 224 and a housing in which bearing 200 may be installed, such as for example articulated joint housing 22A.

In one embodiment as shown in FIGS. 7-9, exterior surface 220 of inner member 214 defines an inner member annular exterior groove 260 in fluid communication with outer member lubrication holes 250. Lubricant 232 is injected into and through outer member lubrication holes 250, is received within inner member annular exterior groove 260, and is dispersed over interior engagement surface 228 of outer member 212 and exterior engagement surface 222 of inner member 212 in the directions indicated by arrows Q and R.

In one embodiment, inner member 214 defines at least one inner member lubrication hole 252 therethrough, and selectively a plurality of inner member lubrication holes 252 therethrough, for providing and replenishing lubricant 232 to interior surface 218 of inner member 214 which is in sliding engagement with shaft 22B extending therethrough. In one embodiment as shown in FIG. 7, interior surface 218 of inner member 214 includes an annular inner member interior groove 261 in fluid communication with inner member lubrication holes 252 to provide dispersion of lubricant 232 between interior surface 218 and shaft 22B extending through the bore 216.

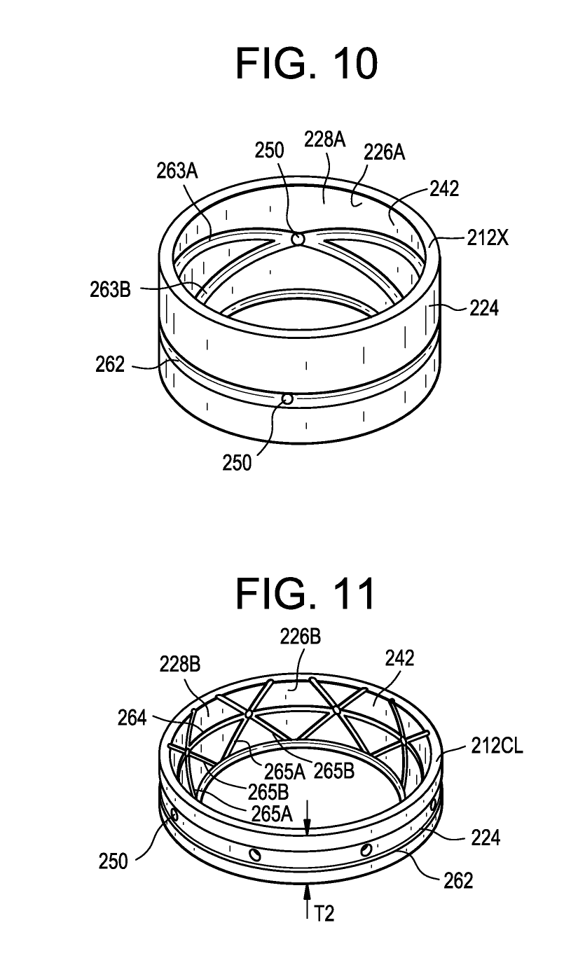

As shown in FIG. 10, one embodiment of outer member 212 of bearing 200 comprises outer member 212X having exterior surface 224 and interior surface 226A which comprises hard coating 242. Outer member 212X includes improvements to lubrication management arrangement 210. Outer member 212X comprises one or more outer member lubrication holes 250 and outer member exterior groove 262 in fluid communication with each of outer member lubrication holes 250. Interior engagement surface 228A of outer member 212X defines a first and a second outer member interior groove 263A and 263B in fluid communication with outer member lubrication holes 250 and inner member annular exterior groove 260. In one embodiment, first and second outer member interior grooves 263A and 263B are configured in a substantially annular and non-parallel crisscross orientation. In one embodiment, first and second outer member interior grooves 263A and 263B intersect at outer member lubrication holes 250. Lubricant 232 is injected into and through outer member lubrication holes 250, is received within first and second outer member interior grooves 263A and 263B, and is dispersed over interior engagement surface 228 of outer member 212 and exterior engagement surface 222 of inner member 212.

As shown in FIG. 11, another embodiment of outer member 212 of bearing 200 comprises outer member 212CL having exterior surface 224, an interior surface 226B which comprises hard coating 242, and a width T2 extending in an axial direction. Outer member 212CL includes further improvements to lubrication management arrangement 210. Outer member 212CL comprises one or more outer member holes 250 and outer member exterior groove 262 in fluid communication with each of outer member lubrication holes 250. Interior engagement surface 228B defines an outer member interior annular groove 264 having a substantially annular configuration and disposed at about a midpoint of width T2 and in fluid communication with outer member lubrication holes 250. Interior engagement surface 228B further defines at least one outer member first interior cross groove 265A and at least one outer member second interior cross groove 265B in fluid communication with outer member lubrication holes 250, and inner member annular exterior groove 260. In one embodiment, interior engagement surface 228B selectively defines a plurality of outer member first interior cross grooves 265A and a corresponding plurality of outer member second interior cross grooves 265B in fluid communication with outer member lubrication holes 250, outer member interior annular groove 264, and inner member annular exterior groove 260. Each of the outer member first and second interior cross grooves 265A and 265B extends substantially axially and is configured in a substantially perpendicular crisscross orientation in relation to each other. In one embodiment, first and second interior cross grooves 265A and 265B intersect at outer member lubrication holes 250. Lubricant 232 is injected into and through outer member lubrication holes 250, is received within outer member interior annular groove 264 and outer member first and second interior cross grooves 265A and 265B, and is dispersed over interior engagement surface 228B of outer member 212CL and exterior engagement surface 222 of inner member 212.

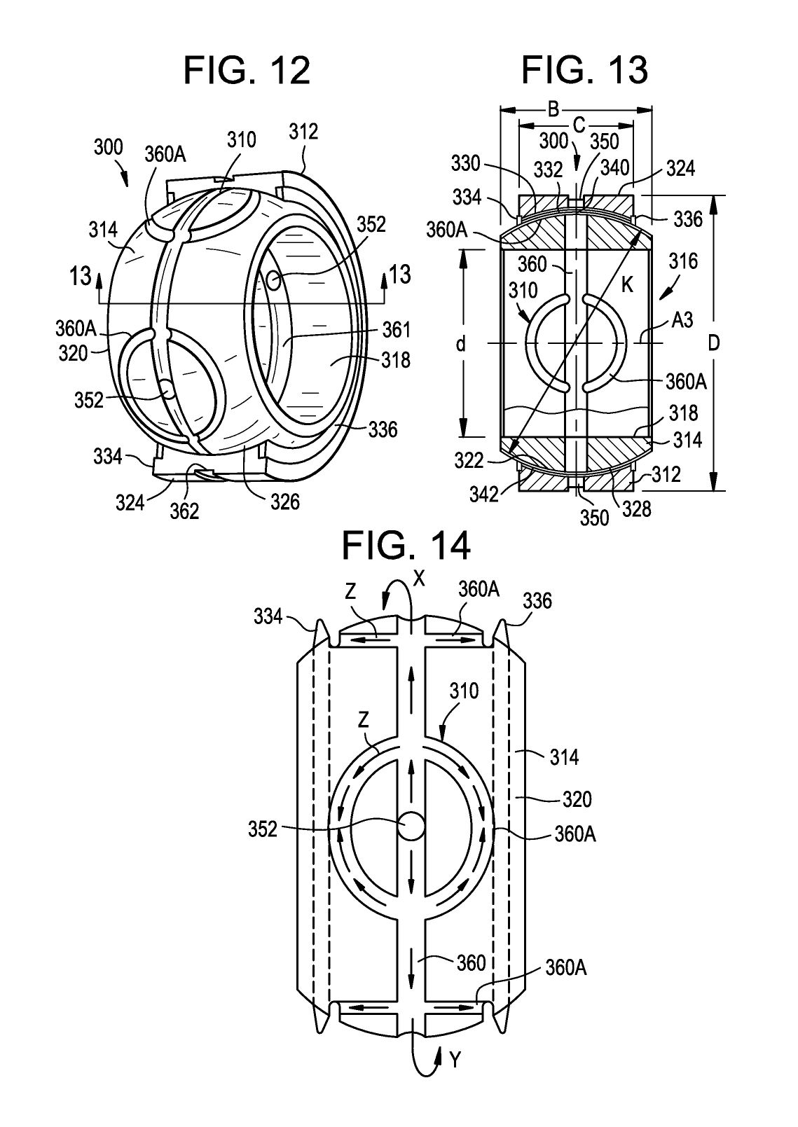

Bearing 300 is depicted in FIG. 12 and is similar to bearing 200 shown in FIGS. 7-11, thus like elements are given a like element number preceded by the numeral 3. Bearing 300 includes a lubrication management arrangement 310.

As shown in FIGS. 12-14, bearing 300 comprises an outer member 312, or outer ring, and an inner member 314, or inner ring, encircled at least partially by the outer member 312. The outer member 312 and the inner member 314 are both generally annular and share a common central axis A3. Inner member 314 includes an interior surface 318 that defines a bore 316 for receiving shaft 22B therethrough. The inner member 314 has an arcuate exterior surface 320, such as a convex spherical surface, a portion of which defines an exterior engagement surface 322. The outer member 312 has a substantially cylindrical exterior surface 324 and an arcuate interior surface, such as but not limited to a concave spherical surface which defines an interior engagement surface 328 of the outer member 312. A radial gap 330 extends between the interior engagement surface 328 of the outer member 312 and the exterior engagement surface 322 of the inner member 314 when the inner member 314 is encircled at least partially by the outer member 312. A lubricant 332 is disposed in the radial gap 330. Lubricant 332 selectively comprises a thin film of grease, a lubricant gel or paste, or the like to reduce friction between the interior engagement surface 328 and the exterior engagement surface 322. In one embodiment as shown in FIGS. 12-14, a first seal 334 and a second seal 336 extend radially across gap 330 to inhibit dust and debris from entering gap 330 and to maintain the lubricant 332 in gap 330. Exterior surface 320 of inner member 314 and interior surface 326 of outer member 312 respectively comprise a hard coating 340 and 342, such as for example a diamond chromium composite matrix coating.

As further shown in FIG. 12-14, bearing 300 includes lubrication management arrangement 310 comprising lubrication holes and grooves for providing and replenishing a lubricant 332. Use of bearing 300 having lubrication management arrangement 310 further improves the distribution of lubricant and facilitates relubrication purging to flush out wear debris and contaminants. Outer member 312 comprises at least one outer member lubrication hole 350 therethrough, and selectively a plurality of outer member lubrication holes 350 therethrough, to provide for the dispersion of lubricant 332 to interior surface 318 of inner member 314. In one embodiment, exterior surface 324 of outer member 312 defines an annular outer member exterior groove 362 in fluid communication with each of outer member lubrication holes 350 to further provide for the dispersion of lubricant 332 therein, and also to provide dispersion of lubricant 332 between exterior surface 324 and a housing in which bearing 300 may be installed, such as for example, articulated joint housing 22A.

In one embodiment as shown in FIGS. 12-14, exterior surface 320 of inner member 314 defines a inner member primary exterior groove, or inner member annular exterior groove 360, in fluid communication with outer member lubrication holes 350. Exterior surface 320 further defines at least one inner member secondary exterior groove, or substantially circular inner member exterior groove 360A, in fluid communication with inner member annular exterior groove 360. Exterior surface 320 selectively defines a plurality of inner member secondary exterior grooves, or substantially circular inner member exterior grooves 360A, in fluid communication with inner member annular exterior groove 360. Lubricant 332 is injected into and through outer member lubrication holes 350, is received within inner member exterior grooves 360 and 360A, and is dispersed over interior engagement surface 328 of outer member 312 and exterior engagement surface 322 of inner member 312 in the directions indicated by arrows X, Y and Z. While the at least one substantially circular inner member exterior groove 360A is shown and described as being substantially circular, the present invention is not limited in this regard as other configurations for the first and second structural members 18 and 20 may be integrally formed with respective first and second sections 12 and 14.

In one embodiment, inner member 314 defines at least one inner member lubrication hole 352 therethrough, and selectively a plurality of inner member lubrication holes 352 therethrough, for providing and replenishing lubricant 332 to interior surface 318 of inner member 314 which is in sliding engagement with shaft 22B extending therethrough. In one embodiment as shown in FIG. 12, interior surface 318 of inner member 314 includes an annular inner member interior groove 361 in fluid communication with inner member lubrication holes 352 to provide dispersion of lubricant 332 between interior surface 318 and shaft 22B extending through the bore 316. The configuration of bearing 300 provides for improved handling of unidirectional loads and heavy loads as well as a potentially omitted lubrication interval of the bearing.

Bearing 200, including lubrication management arrangement 210 and selectively including one of outer members 212, 212X and 212CL, exhibits the same size capacity and precision ratings as conventional spherical plain bearings with the same envelope. Similarly, bearings 300, including lubrication management arrangement 310, exhibits the same size capacity and precision ratings as conventional spherical plain bearings with the same envelope. A bearing 200 or 300 can be provided in an articulated joint of a newly constructed articulating vehicle without requiring any modification to structural components such as housings or shafts. A bearing 200 or 300 also can be retrofitted in an articulated joint of an existing articulating vehicle such as by repair or overhaul of such articulated joint without requiring any modification to structural components such as housings or shafts.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A spherical plain bearing configured for use within an articulated joint in an articulating vehicle, the spherical plain bearing comprising:
an outer member defining an exterior surface and an interior surface which defines an interior engagement surface;
an inner member encircled at least partially by the outer member, the inner member having an interior surface defining a bore therethrough, and an exterior surface defining an exterior engagement surface;
a radial gap extending between the interior engagement surface and the exterior engagement surface;
a lubricant disposed in the radial gap; and
a hard coating disposed on the interior engagement surface and the exterior engagement surface; and
the hard coating comprising a diamond chromium composite matrix coating.

2. The spherical plain bearing of claim 1, the diamond chromium composite matrix coating having a depth of up to about 0.0005 inch.

3. The spherical plain bearing of claim 1, the diamond chromium composite matrix coating having a depth in the range of about 0.0001 inch to about 0.0003 inch.

4. The spherical plain bearing of claim 1, further comprising a lubrication management arrangement.

5. The spherical plain bearing of claim 1, further comprising:
at least one outer member lubrication hole defined in the outer member.

6. The spherical plain bearing of claim 5, further comprising:
an inner member primary exterior groove defined in the exterior engagement surface and in fluid communication with the outer member lubrication hole.

7. The spherical plain bearing of claim 5, further comprising:
an annular outer member exterior groove defined in the exterior surface of the outer member and in fluid communication with the outer member lubrication hole.

8. The spherical plain bearing of claim 6, further comprising:
a first outer member interior groove defined in the interior engagement surface and in fluid communication with the outer member lubrication hole and the inner member primary exterior groove; and
a second outer member interior groove defined in the interior engagement surface and in fluid communication with the outer member lubrication hole and the inner member primary exterior groove;
the first and second outer member interior grooves configured in a substantially annular and non-parallel crisscross orientation.

9. The spherical plain bearing of claim 8, the first and second outer member interior grooves intersecting at the outer member lubrication hole.

10. The spherical plain bearing of claim 6, further comprising:
an outer member interior annular groove defined in the interior engagement surface, the outer member interior groove in fluid communication with the outer member lubrication hole and the inner member primary exterior groove;
at least one outer member first interior cross groove defined in the interior engagement surface and in fluid communication with the outer member interior annular groove; and
at least one outer member second interior cross groove defined in the interior engagement surface and in fluid communication with the outer member interior annular groove;
the first and second interior cross grooves extending substantially axially and configured in a substantially perpendicular crisscross orientation in relation to each other.

11. The spherical plain bearing of claim 10, further comprising:
a plurality of outer member lubrication holes defined in the outer member;
the first and second interior cross grooves intersecting at one of the plurality of outer member lubrication holes.

12. The spherical plain bearing of claim 6, further comprising:
an inner member secondary exterior groove defined in the exterior engagement surface and in fluid communication with the inner member secondary exterior groove.

13. The spherical plain bearing of claim 6, further comprising:
a plurality of inner member secondary exterior grooves defined in the exterior engagement surface and in fluid communication with the inner member secondary exterior groove.

14. The spherical plain bearing of claim 12, the inner member secondary exterior groove defining a substantially circular configuration.

15. The spherical plain bearing of claim 1, further comprising:
a first seal positioned proximate to a first end of the outer member; and
a second seal positioned proximate to a second end of the outer member;
the first and second seals extending radially across the radial gap.

16. An articulated joint of an articulating vehicle, the articulated joint comprising:
a first structural member extending rearwardly from a forward section of the articulating vehicle, the first structural member defining a bore at an aft end thereof;
a second structural member extending forwardly from an aft section of the articulating vehicle, the first structural member defining a bore at an aft end thereof;
an articulated joint housing received within the first structural member bore and the second structural member bore; and
a spherical plain bearing disposed in the articulated joint housing, the spherical plain bearing configured for use within an articulated joint in an articulating vehicle and comprising,
an outer member defining an exterior surface and an interior surface which defines an interior engagement surface,
an inner member encircled at least partially by the outer member, the inner member having an interior surface defining a bore therethrough, and an exterior surface defining an exterior engagement surface,
a radial gap extending between the interior engagement surface and the exterior engagement surface,
a lubricant disposed in the radial gap,
a diamond chromium composite matrix coating disposed on the interior engagement surface and the exterior engagement surface, and
a lubrication management arrangement having at least one outer member lubrication hole defined in the outer member, at least one inner member exterior groove defined in the exterior engagement surface and in fluid communication with the outer member lubrication hole.

17. The articulated joint of claim 16, the diamond chromium composite matrix coating having a depth of up to about 0.0005 inch.

18. The articulated joint of claim 16, the diamond chromium composite matrix coating having a depth in the range of about 0.0001 inch to about 0.0003 inch.

19. A method for providing and replenishing a lubricant in an articulated joint of an articulating vehicle, the method comprising:
providing an articulated joint housing received within a bore at an aft end of a first structural member extending rearwardly from a forward section of the articulating vehicle and a bore at a forward end of a second structural member extending forwardly from an aft section of the articulating vehicle;
providing a spherical plain bearing disposed in the articulated joint housing, the spherical plain bearing configured for use within an articulated joint in an articulating vehicle and comprising,
an outer member defining an exterior surface and an interior surface which defines an interior engagement surface,
an inner member encircled at least partially by the outer member, the inner member having an interior surface defining a bore therethrough, and an exterior surface defining an exterior engagement surface,
a radial gap extending between the interior engagement surface and the exterior engagement surface,
a lubricant disposed in the radial gap,
a diamond chromium composite matrix coating disposed on the interior engagement surface and the exterior engagement surface, and
a lubrication management arrangement having at least one outer member lubrication hole defined in the outer member, at least one inner member exterior groove defined in the exterior engagement surface and in fluid communication with the outer member lubrication hole;
injecting the lubricant into the spherical plain bearing lubrication management arrangement through the outer member lubrication hole to the inner member exterior groove and dispersing the lubricant over the interior engagement surface and the exterior engagement surface.
